(19) United States
(12) Patent Application Publication
(10) Pub. No.: US 2012/0224767 A1
(43) Pub. Date: Sep. 6, 2012

(54) IMAGE PROCESSING APPARATUS, IMAGE PROCESSING METHOD, AND STORAGE MEDIUM

(75) Inventor: Tomohiro Matsui, Tokyo (JP)

(73) Assignee: CANON KABUSHIKI KAISHA, Tokyo (JP)

(21) Appl. No.: 13/408,332

(22) Filed: Feb. 29, 2012

(30) Foreign Application Priority Data
Mar. 4, 2011 (JP) 2011-047912

(51) Int. Cl. G06K 9/00

(52) U.S. Cl. 382/162

(57) ABSTRACT

An image processing apparatus includes a management unit configured to manage relevant information for associating color reproduction information and user identification information and relevant information for associating the user identification information to each other, an image reception unit configured to receive original image data together with the user identification information, a generation unit configured to generate image data after matching by performing color matching processing on the original image data received by the image reception unit by using the color reproduction information specified based on the user identification information received by the image reception unit and the relevant information managed by the management unit, and a storage unit configured to store the image data after matching generated by the generation unit in a database.

### BACKGROUND OF THE INVENTION

1. Field of the Invention

The present invention relates to an image processing apparatus, an image processing method, and a storage medium storing a computer program thereof, and in particular, to an image processing apparatus and an image processing method for executing color matching processing, and a storage medium storing a computer program thereof.

2. Description of the Related Art

Conventionally, color matching is performed for color management using a color profile (hereinafter, simply referred to as a profile) that describes characteristics of a color space of an input or output device. An outline of conventional color matching using such a profile is as follows.

By using the profile of the input device, input data of a red-green-blue (RGB) or cyan-magenta-yellow-black (CMYK) color space depending on the device is converted into XYZ data or Lab data as color space data independent of the device.

The output device cannot express colors positioned outside the color reproduction range thereof. Therefore, the converted input data is subjected to color space compression so that all colors are included within the color reproduction range of the output device.

After the color space compression, with a profile of the output device, the input data after the color space compression is converted from the color space data independent of the device to RGB or CMYK color space data depending on the output device.

As discussed in Japanese Patent Application Laid-Open No. 2004-023741, a server manages device identification information and a device profile by relating thereof on a network. The server performs color matching processing of image data based on the profile corresponding to a device that requests the image data, and transmits the image data (image data after matching) after the color matching to the device.

A cloud service has started to be provided to perform processing that was executed by a device under a local environment by a server connected to a device as a client via the Internet. It is demanded for the service that a user can easily and quickly acquire a processing result.

If the color matching processing is provided by such a service, by the technique discussed in Japanese Patent Application Laid-Open No. 2004-023741, when the client requests the image data, the color matching processing is executed. Therefore, the time period for acquiring the image data after matching as the processing result by the client is delayed by the time period of the color matching processing.

To improve the problem, the color matching processing allows prior generation of the image data after matching and storage thereof to a database. Further, when receiving a request from the client, the image data after matching may be transmitted to the client.

With the cloud service, a large indefinite number of clients accesses data on the server. Therefore, if the server performs the color matching processing with profiles (e.g., all profiles managed by the server) of accessible clients (output devices), and a plurality of the acquired image data after matching is stored in the server, the server storage area and processing resources are greatly consumed.

### SUMMARY OF THE INVENTION

According to an aspect of the present invention, an image processing apparatus includes a management unit configured to manage relevant information for associating color reproduction information and user identification information and relevant information for associating the user identification information to each other, an image reception unit configured to receive original image data together with the user identification information, a generation unit configured to generate image data after matching by performing color matching processing on the original image data received by the image reception unit by using the color reproduction information specified based on the user identification information received by the image reception unit and the relevant information managed by the management unit, and a storage unit configured to store the image data after matching generated by the generation unit in a database.

According to the present invention, information for identifying a user is managed by associating thereof to each other. As a consequence, image data for color matching processing can be narrowed, and a server storage area and processing resources can be advantageously used.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration according to a first exemplary embodiment of the present invention.

FIG. 2 illustrates an association chart of internal processing of the system according to the first exemplary embodiment.

FIG. 3 illustrates a user interface (UI) when uploading user information.

FIG. 4 illustrates a data format when transmitting an image to a server.

FIG. 5 illustrates a table of image transmission client identifications (IDs) and image reception client IDs.

FIG. 6 illustrates a table of the image transmission client IDs and device profiles.

FIG. 7 illustrates a table of the image reception client IDs and the device profiles.

FIG. 8 illustrates a storage table of original images.

FIG. 9 illustrates a storage table of images after matching.

FIG. 10 illustrates an image request data format.

FIG. 11 illustrates a flowchart of color matching processing.

FIG. 12 illustrates a UI when uploading user information of an image reception client.

FIG. 13 illustrates a data format when transmitting the user information of the image reception client.

FIG. 14 illustrates a data format when transmitting all image transmission client IDs.

FIG. 15 illustrates a UI for image viewing.

FIG. 16 illustrates a flowchart when updating a device profile of the image reception client.

FIG. 17 illustrates an association chart of internal processing of the system according to the second exemplary embodiment.

FIG. 18 illustrates an example of a system configuration according to a third exemplary embodiment of the present invention.

FIG. 19 illustrates a UI for setting an image storage period.

FIG. 20 illustrates a storage table of original images according to the third exemplary embodiment.

### DESCRIPTION OF THE EMBODIMENTS

Various exemplary embodiments, features, and aspects of the invention will be described in detail below with reference to the drawings.

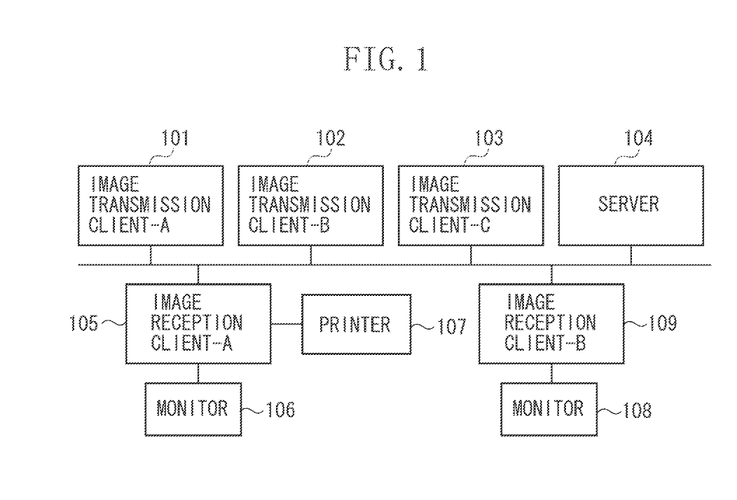

Embodiments of the present invention are described with reference to the drawings. FIG. 1 illustrates an example of a configuration of an image processing system including an image processing apparatus and an information processing apparatus according to a first exemplary embodiment of the present invention.

Image transmission clients (information processing apparatuses) 101, 102, and 103 can upload image data to a server 104 via a network. The image transmission clients 101 to 103 each include a central processing unit (CPU), a read only memory (ROM), a random access memory (RAM), and a hard disk drive (HDD) (not illustrated). The ROM in each of the image transmission clients 101 to 103 stores a program for starting the device of the image transmission clients and a program for functioning the CPU therein as processing units 201 and 202 described below. The CPU in each of the image transmission clients 101 to 103 reads and executes the programs to the RAM therein to execute the processing.

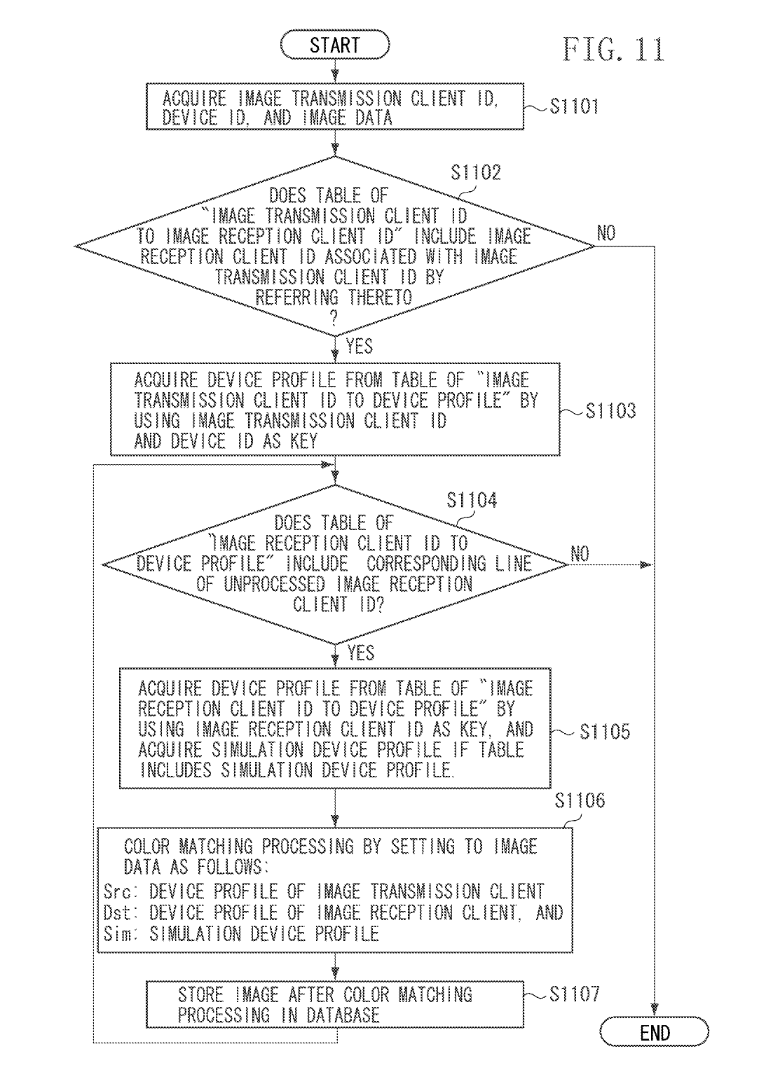

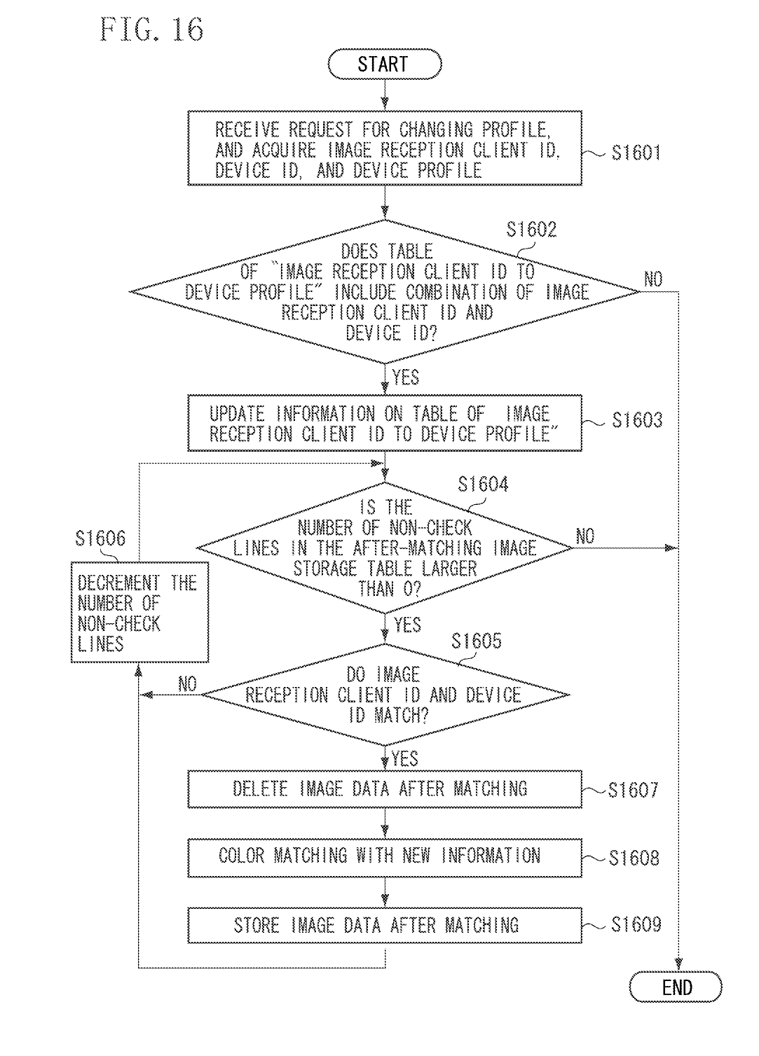

The server (image processing apparatus) 104 receives image data from the image transmission clients 101 to 103. The server 104 includes a CPU, a ROM, a RAM, and an HDD (not illustrated). The ROM in the server 104 stores a start program of the server 104 and a program for executing processing illustrated in flowcharts in FIGS. 11 and 16. The CPU in the server 104 reads the programs to the RAM therein and executes them to perform processing by processing units 203 to 209. The server 104 stores the image data received from the image transmission clients 101 to 103 to the HDD (database) therein, further performs color conversion (color matching processing) of the stored image data, and then stores the image data after color conversion to the database. The server 104 further transmits the image data after color conversion generated and stored in advance in the database to an image reception client in response to an image data request command from the image reception client to be described below.

Image reception clients (information processing apparatuses) 105 and 109 transmit an image data request command to the server 104, and receive the color-converted image data. The image reception clients 105 and 109 each contain a CPU, a ROM, a RAM), and an HDD (not illustrated). The ROM in each of the image reception clients 105 and 109 stores a program for starting the image reception clients and a program that causes the CPU therein to function as processing units 210 to 212. The CPU in each of the image reception clients 105 and 109 reads the programs to the RAM therein and executes the read programs to perform the processing. Monitors 106 and 108 or a printer 107 displays or outputs the image data received from the server 104 in response to the commands from the image reception clients 105 and 109.

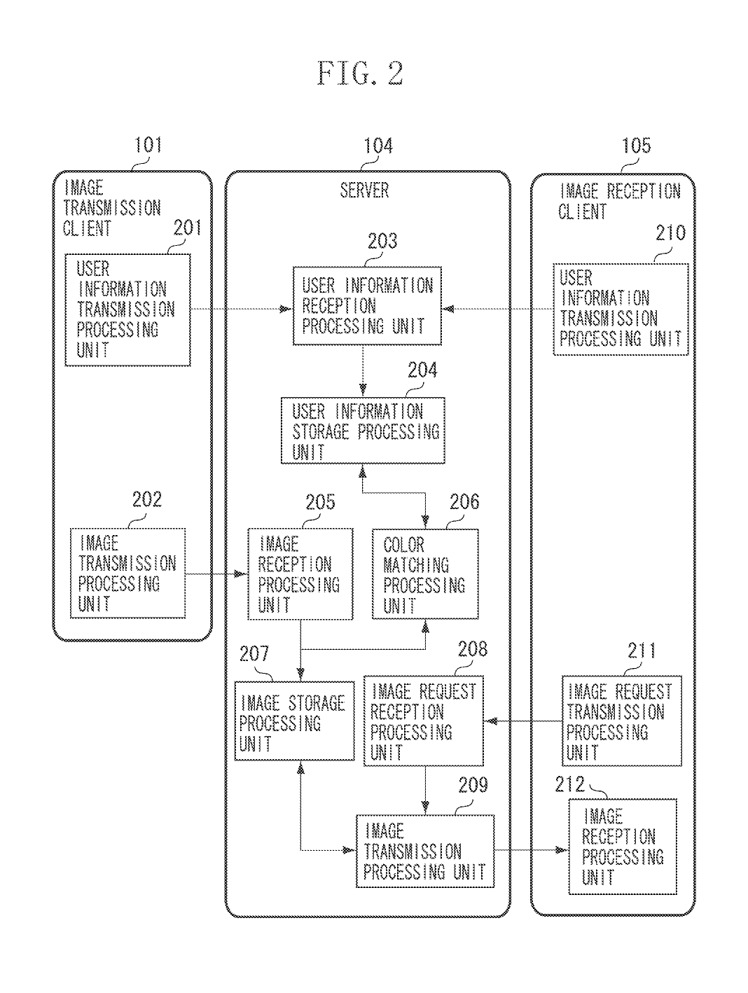

FIG. 2 is a block diagram illustrating the relationship among functions of the network system in FIG. 1. The network system is realized by executing the programs stored in the ROM in each of the image transmission clients 101 to 103, the server 104, and the image reception clients 105 and 109 described referring to FIG. 1. Although FIG. 2 does not illustrate the image transmission clients 102 and 103, the image transmission clients 102 and 103 are connected to the server 104 with the similar configuration of the image transmission client 101. Although FIG. 2 does not illustrate the image reception client 109, the image reception client 109 is connected to the server 104 with the similar configuration of the image reception client 105. Although FIG. 2 does not illustrate the monitors 106 and 108 and the printer 107 in FIG. 1, the monitors 106 and 108 and the printer 107 are connected to the image reception clients 105 and 109 as illustrated in FIG. 1.

The user information transmission processing unit 201 is a first relevant information transmission unit. The user information transmission processing unit 201 transmits information for identifying a user (user identification information), information for identifying a device (device identification information), and color reproduction information of the device to the server 104 before transmitting the image data to the server 104. The user identification information, the device identification information, and the color reproduction information are associated to each other. According to the present exemplary embodiment, the user identification information transmitted from the image transmission client 101 is an image transmission client identification (ID). Note that the image transmission client ID is not for specifying the client computer, but for specifying the user, such as a login name of the user, a login ID of the user or the like. Further, the device identification information is a device ID of the image transmission client 101. Furthermore, the color reproduction information of the device is a device profile acquired from the device of the image transmission client 101. In addition, the color reproduction information is the device profile according to the present exemplary embodiment. Alternatively, any color reproduction information may be used as long as the information is related the color reproduction of the device.

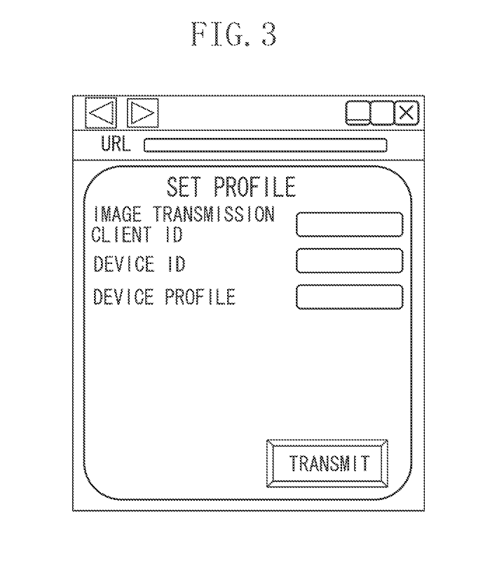

FIG. 3 illustrates a user interface (UI) for setting information on the image transmission client ID as the user identification information transmitted to the server 104 by the user information transmission processing unit 201, the device ID as the device identification information, and the device profile as the color reproduction information of the device. The UI is displayed on a display unit (not illustrated) of the image transmission client 101 in response to an instruction of the user information transmission processing unit 201, and prompts the user to set the information.

After setting the information, the user presses a transmission button on the user interface in FIG. 3. As a consequence, the image transmission client ID, the device ID, and the device profile are transmitted from the user information transmission processing unit 201 in the image transmission client 101 to the user information reception processing unit 203 in the server 104. If any data is not input as the image transmission client ID, a single ID that can be identified in the server 104 is assigned. If any data is not input as the device ID, a media access control (MAC) address of the device is transmitted. According to the present exemplary embodiment, the device profile transmitted from the image transmission client 101 is a camera profile of a camera that captures image data to be transmitted by an image transmission processing unit or a monitor profile of the client that is used to edit the image data.

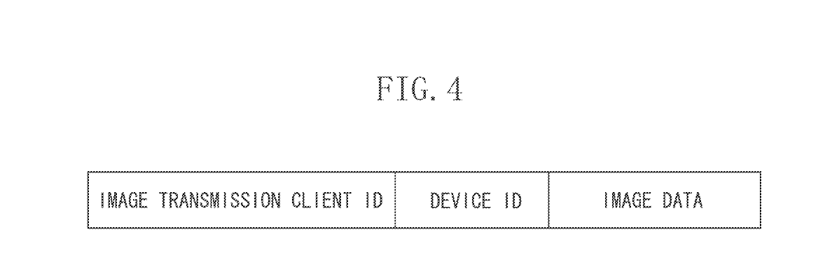

The image transmission processing unit 202 (data transmission unit) transmits the image data together with the image transmission client ID and the device ID to the image reception processing unit 205 in the server 104. FIG. 4 illustrates a data format transmitted by the image transmission processing unit 202, that is, the image data and data of a combination of the image transmission client ID and the device ID corresponding to the image data.

The user information reception processing unit 203 (user information reception unit) receives the image transmission client ID, the device ID of the image transmission client 101, and the device profile of the image transmission client 101, transmitted from the user information transmission processing unit 201 in the image transmission client 101.

The user information reception processing unit 203 also receives information transmitted from the user information transmission processing unit 210 in the image reception client 105. The information transmitted by the user information transmission processing unit 210 in the image reception client 105 includes information (user identification information) for identifying the user of the image reception client 105, information (device identification information) for identifying the device of the image reception client 105, color reproduction information on the device of the image reception client 105, device identification information of a simulation target device, and color reproduction information of the simulation target device. The user identification information can be the image reception client ID. The device identification information can be the device ID of the image reception client 105. The color reproduction information of the device can be the device profile of the image reception client 105. According to the present exemplary embodiment, the device profile of the image reception client 105 is, for example, a monitor profile of the monitor that displays the image data after matching.

The device identification information of the simulation target device is a simulation device ID of the image reception client 105. The color reproduction information of the simulation target device is a simulation device profile (simulation profile) of the image reception client 105. According to the present exemplary embodiment, a simulation profile of the image reception client 105 includes a printer profile of the printer that prints the image data after matching to be described below. As described above, the color reproduction information is the device profile and the simulation profile according to the present exemplary embodiment. Alternatively, any color reproduction information may be used as long as the information is related to the color reproduction of the device.

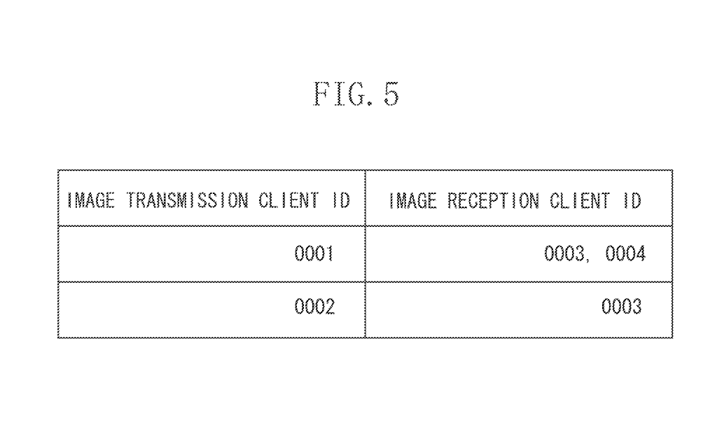

A user information storage processing unit 204 (management unit) stores information received by the user information reception processing unit 203 to the database. The user information storage processing unit 204 has a function for storing the information received by the user information reception processing unit 203, as associated tables (a table of the image transmission client ID to the image reception client ID, a table of the image transmission client ID to the device profile, and a table of the image reception client ID to the device profile), to the database in the server 104. FIGS. 5, 6, and 7 illustrate storage formats thereof.

FIG. 5 is a table (table of the image transmission client ID to the image reception client ID) illustrating a relationship between the image transmission client ID and the image reception client ID. The table includes information (first relevant information) indicating that the user identification information is related to each other, and is generated from the information transmitted from the user information transmission processing units 201 and 210.

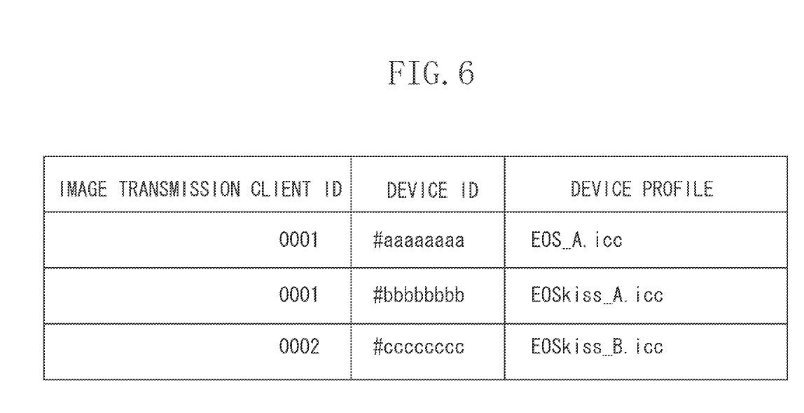

FIG. 6 is a table (table of the image transmission client ID to the device profile) illustrating a relationship among the image transmission client ID, the device ID of the image transmission client 101, and the device profile of the image transmission client 101. That is, the table includes information (second relevant information) indicating a relationship among the color reproduction information (first color reproduction information), the user identification information (first user identification information), and the device identification information (first device identification information) transmitted from the image transmission client 101. The table is generated from the data transmitted from the user information transmission processing unit 201.

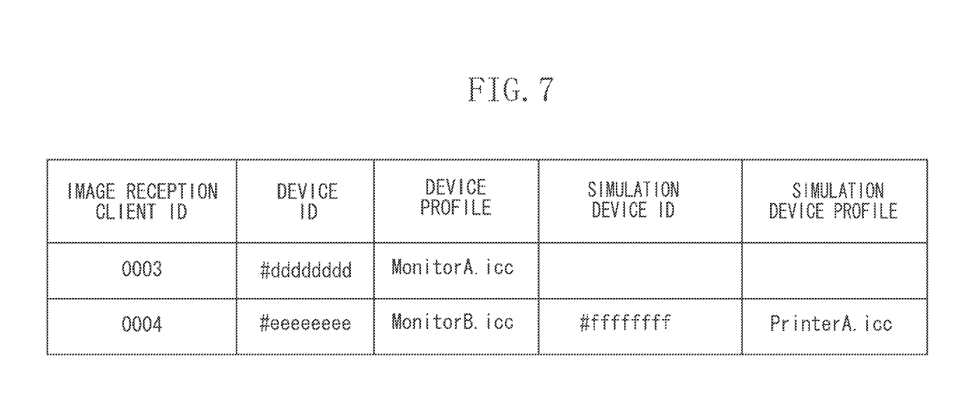

FIG. 7 is a table (table of the image reception client ID to the device profile) illustrating a relationship among the image reception client ID, the device ID of the image reception client 105, and the device profile. If there is a simulation target device, the table also illustrates a relationship between the simulation device ID and the simulation profile. That is, the table includes information (third relevant information) indicating a relationship among the color reproduction information (second color reproduction information), the user identification information (second user identification information), and the device identification information (second device identification information) transmitted from the image reception client 105. The table is generated from the data transmitted by the user information transmission processing unit 210.

The image reception processing unit 205 (image reception unit) receives the data transmitted from the image transmission processing unit 202 in the image transmission client 101. The data format of the received data is as illustrated in FIG. 4. The image reception processing unit 205 transmits the received image data to the image storage processing unit 207.

The color matching processing unit 206 (generation unit) performs the color matching of the image data stored in the image storage processing unit 207. FIG. 11 is a flowchart illustrating the details of the color matching. The flowchart in FIG. 11 is realized by reading a program for executing the flowchart stored in the ROM in the server 104 to the RAM therein and executing the read program by the CPU therein. Primarily, the color matching processing unit 206 performs the flowchart.

In step S1101, the image data stored in the image storage processing unit 207 (storage unit), the image transmission client ID related to the image data, and the device ID are acquired from an image table corresponding to the user in the data format in FIG. 4.

In step S1102, the image reception client ID related to the acquired image transmission client ID is acquired by referring to the table of the image transmission client ID to the image reception client ID. If there is no image reception client ID related to the acquired image transmission client ID (NO in step S1102), the color matching processing is not performed and the color matching processing unit 206 ends the processing.

If there is at least one corresponding image reception client ID related to the acquired image transmission client ID (YES in step S1102), in step S1103, the image transmission client ID acquired in step S1101 and the device profile related to the device ID are acquired by referring to the transmission device table.

In step S1104, it is determined whether the table of the image reception client id to the device profile includes corresponding line of unprocessed image reception client id. In other words, in step S1104, it is determined whether the image reception client IDs acquired in step S1102 include an unprocessed image reception client ID. If the image reception client IDs do not include the unprocessed image reception client ID (NO in step S1104), the color matching processing ends.

If the image reception client IDs include the unprocessed image reception client ID (YES in step S1104), in step S1105, a set of the device profile related to the image reception client ID acquired in step S1102 and the simulation profile is acquired by referring to the table of the image reception client ID to the device profile. In step S1106, the color matching processing unit 206 sets the device profile acquired in step S1103 as a source profile (Src), and sets the device profile acquired in step S1105 as a destination profile (Dst), and further sets the simulation profile as a simulation device profile (Sim).

Then, the color matching processing unit 206 performs the color matching processing of the image data (original image data) acquired in step S1101 by using the profiles acquired in steps S1103 and S1105. According to the present exemplary embodiment, in the color matching processing, the color of the image data of the device specified by the device ID of the image transmission client is reproduced by the device ID of the image reception client or the device specified by the simulation device ID.

Instep S1107, image data (image data after matching) on the color matching processed image acquired in the processing in step S1106 is stored to the database, and information on the image data after matching is additionally registered to the after-matching image storage table. Then, the processing returns to step S1104.

According to the present exemplary embodiment, parameters are fixed in the system, except for the profiles (device profile and simulation profile) used by the color matching of the color matching processing unit 206. However, the parameters can be acquired from the image transmission client or the image reception client via the user information transmission processing unit 201 and the user information transmission processing unit 210. The parameters fixed in the system are “Perceptual” in rendering intent according to the present exemplary embodiment.

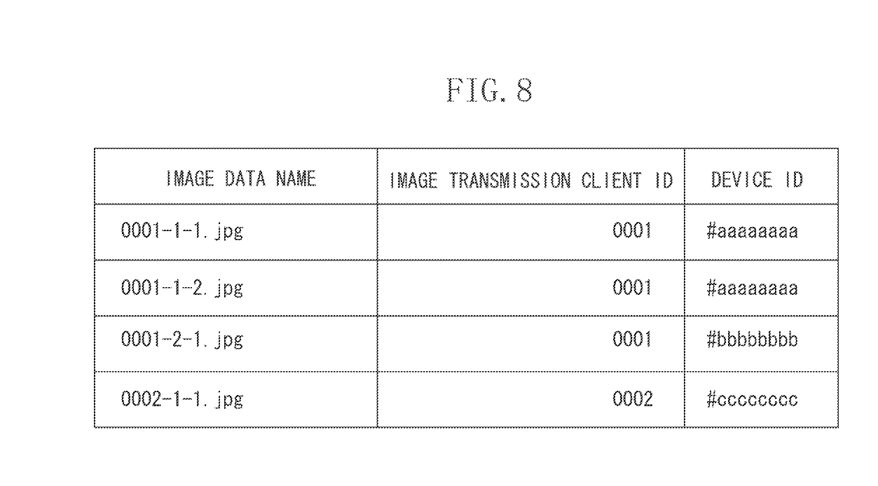

The image storage processing unit 207 executes processing for storing the data received by the image reception processing unit 205 and processing for storing data after the processing of the color matching processing unit 206. FIG. 8 is a table (original image storage table) illustrating a management format of the image data received by the image reception processing unit 205. The table contains the image data, the image transmission client ID, and the device ID of the image transmission client. The image storage processing unit 207 updates the original image storage table each time when storing the original image data to the database.

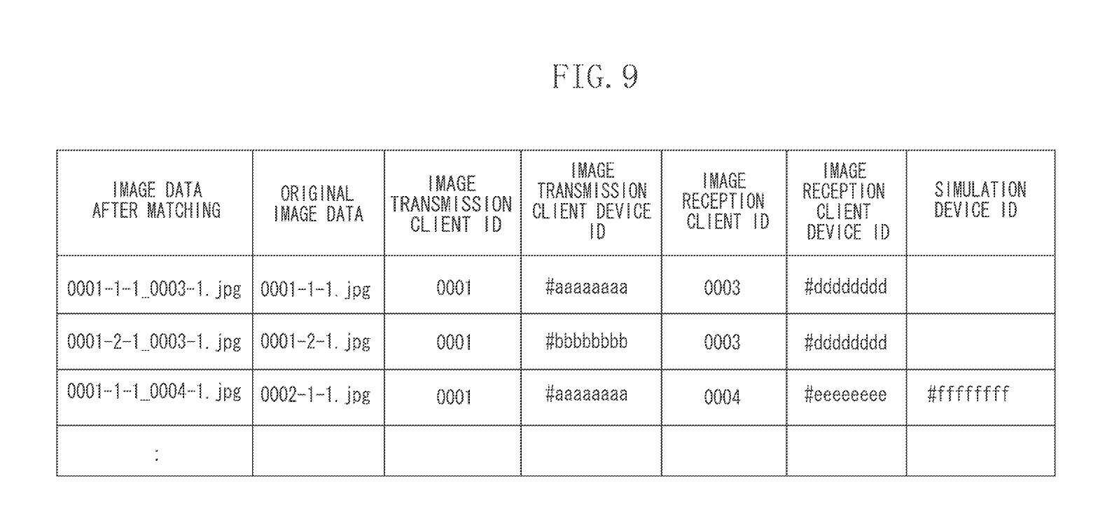

FIG. 9 is a table (after-matching image storage table) illustrating the management format of the image data after matching generated by the color matching processing unit 206. The table contains the image data after matching, the original image data, the image transmission client ID, the device ID of the image transmission client, the image reception client ID, the device ID of the image reception client, and the simulation device ID. The image storage processing unit 207 updates the after-matching image storage table each time storing the image data after matching to the database.

The image request reception processing unit 208 receives an image request command of the image data after matching from the image request transmission processing unit 211 of the image reception client, and checks whether the image request command is correct. When the image request command is correct, the processing for transmitting the image transmission instruction to the image transmission processing unit 209 is performed.

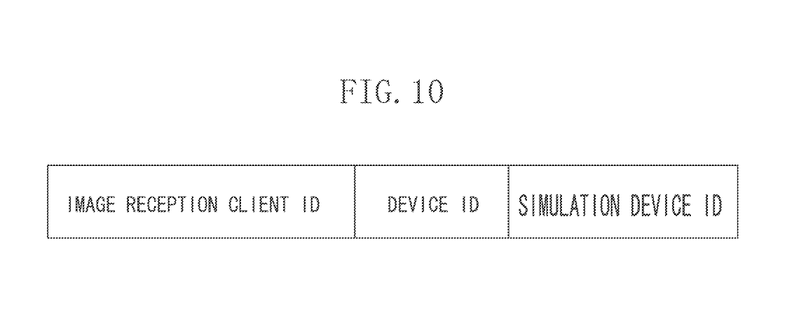

FIG. 10 illustrates a data format transmitted from the image request transmission processing unit 211 to the image request reception processing unit 208, including the image reception client ID and the device ID of the image reception client, and the simulation device ID. If the simulation device ID is not required, blank information (e.g., NULL) is set as the simulation device ID. It is determined whether an image request by the image request reception processing unit 208 is appropriate by checking whether the table of the image reception client ID to the device profile in FIG. 7 stored by the user information storage processing unit 204 includes the image reception client ID, the device ID of the image reception client, and the simulation ID. If the image request is appropriate, an image transmission command including information on the image reception client ID, the device ID of the image reception client, and the simulation ID is transmitted to the image transmission processing unit 209.

The image transmission processing unit 209 receives the image transmission command from the image request reception processing unit 208, and further transmits the corresponding image data after matching to the image reception processing unit 212 by referring to the after-matching image storage table. The image data after matching has the matching image reception client ID acquired from the image request reception processing unit 208, device ID of the image reception client, and simulation device ID on the storage table (in FIG. 9) of the image after the matching.

The user information transmission processing unit 210 (second relevant information transmission unit) of the image reception client transmits in advance the user identification information, the device identification information, the color reproduction information of the image reception client to the server 104, and the image transmission client ID (more than one can be transmitted) before requesting the image data after matching to the server 104.

The user identification information, the device identification information, and the color reproduction information are associated. According to the present exemplary embodiment, the user identification information transmitted from the image reception client is the image reception client ID, the device identification information is the device ID of the image reception client, and the color reproduction information of the device is the device profile acquired from the device of the image reception client. According to the present exemplary embodiment, the color reproduction information is the device profile. Any color reproduction information may be used as long as the information is related to the color reproduction of the device.

The user information transmission processing unit 210 transmits the device ID of a simulation target device (e.g., printer) and the device profile of the simulation target device to the server 104 in response to a user request.

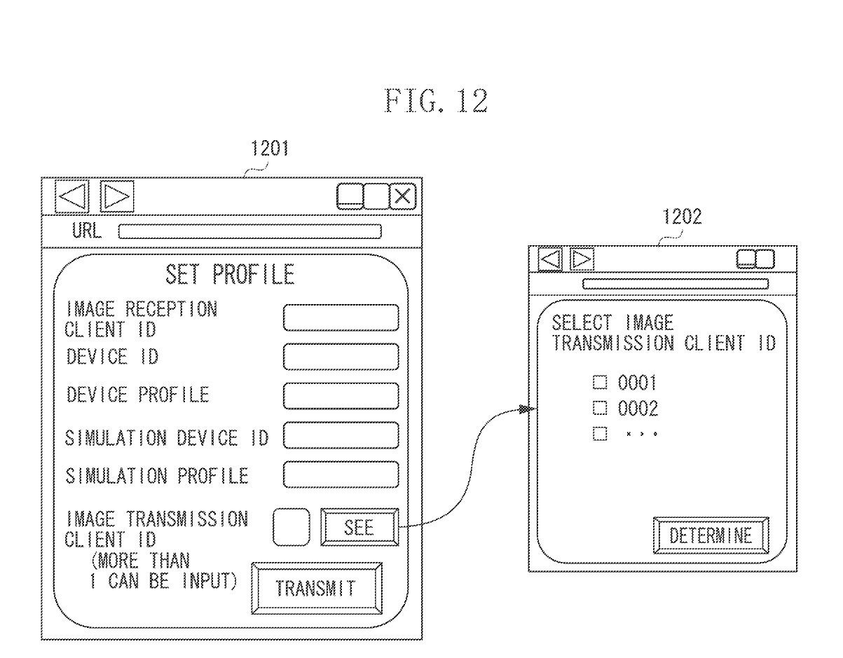

FIG. 12 illustrates the user interface used by the user information transmission processing unit 210. An image transmission client ID selection window 1202 is displayed by pressing a reference button in a profile setting window 1201. The image transmission client ID selection window 1202 displays the image transmission client ID registered to the server 104 by the user information transmission processing unit 201, and the user can select a plurality of image transmission client IDs that can be associated to the image reception client ID.

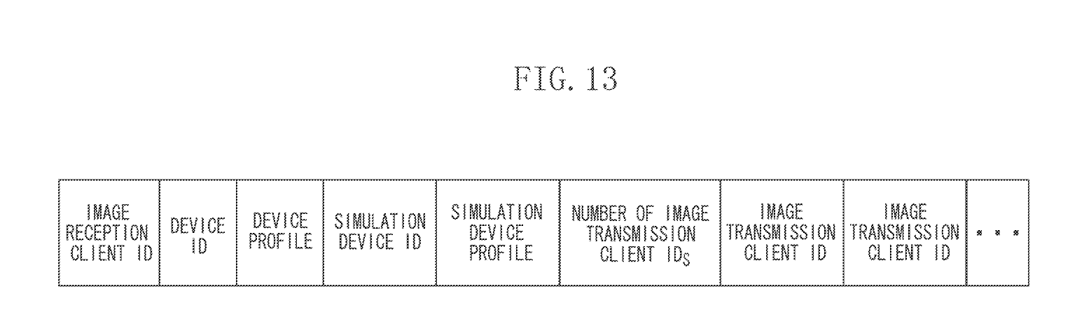

The user presses a transmission button on the profile setting window 1201, thereby transmitting the image reception client ID, the device ID and the device profile of the image reception client, and the device ID and the device profile of the simulation target device, and the selected image transmission client ID to the server 104 (user information reception processing unit 203). FIG. 13 illustrates a data format transmitted from the user information transmission processing unit 210 to the user information reception processing unit 203.

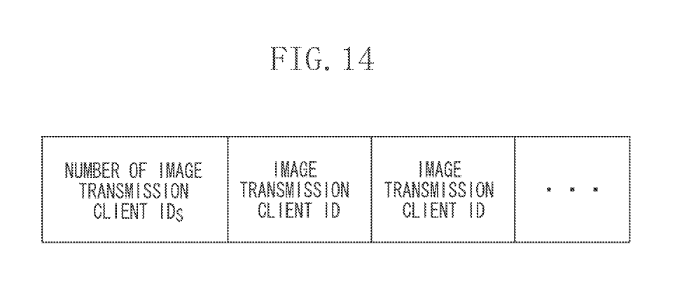

FIG. 14 illustrates a data format transmitted from the user information reception processing unit 203 to the user information transmission processing unit 210 in order to transmit the image transmission client ID from the server 104 to the image reception client. The tables in FIGS. 5 and 7 are formed based on the data in the format in FIG. 14.

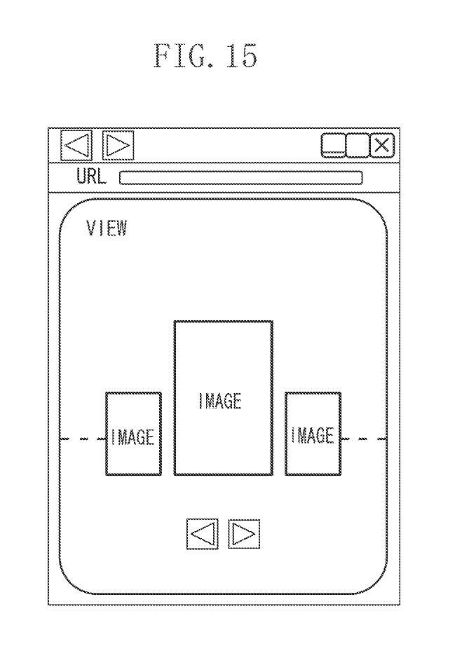

The image request transmission processing unit 211 (image requesting unit) requests the image from the image reception client to the server 104. FIG. 10 illustrates a format of transmission data. The image reception processing unit 212 receives the image data transmitted from the image transmission processing unit 209. FIG. 15 illustrates a user interface (UI) that displays the received image data.

Processing of the server 104 when the device profile is changed will be described next. The processing is performed on assumption that that the user information storage processing unit 204 has already registered the device profile to the server 104.

The device profile of the image transmission client is changed via the user interface (UI) illustrated in FIG. 3. If the table of the image transmission client ID to the device profile includes the combination of the image transmission client ID and the device ID acquired via the UI in FIG. 3, the device profile information in the table of the image transmission client ID to the device profile is updated with the device profile designated by the UI in FIG. 3. If the table of the image transmission client ID to the device profile does not include the combination of the image transmission client ID and the device ID, addition processing is performed, that is, registration processing of the device profile is performed in place of changing the device profile.

The device profile changing of the image reception client will be described with reference to FIG. 16. A flowchart in FIG. 16 is realized by the CPU reading to the RAM therein a program for executing the flowchart stored in the ROM in the server 104 and executing the program.

In step S1601, the user information transmission processing unit 210 transmits a request for changing the device profile of the image reception client to the server 104 (user information reception processing unit 203) in response to a user instruction. The server 104 (user information reception processing unit 203) receives the request for changing the profile from the user information transmission processing unit 210 via the interface in FIG. 12. The user information transmission processing unit 210 acquires the image reception client ID, the device ID, and the changed device profile via the interface. The user information transmission processing unit 210 transmits the image reception client ID, the device ID, and the device profile after change to the server 104 (user information reception processing unit 203).

In step S1602, it is determined whether a combination of the image reception client ID and device ID is acquired by referring to the table of the image reception client ID to the device profile. If the combination of the image reception client ID and device ID is acquired by referring to the table of the image reception client ID to the device profile (YES in step S1602), in step S1603, the server 104 (user information storage processing unit 204) updates information on the device profile in the table, related to the acquired image reception client ID and device ID, with the device profile acquired in step S1601.

If the combination of the image reception client ID and device ID is not acquired by referring to the table of the image reception client ID to the device profile (NO in step S1602), the server 104 (user information storage processing unit 204) ends the change processing. Then, the registration processing of the device profile is performed.

After step S1603, in step S1604, it is checked whether the number of non-check lines in the after-matching image storage table is larger than 0 (zero). If the number of non-check lines in the after-matching image storage table is not larger than 0 (NO in step S1604), the server 104 ends the change processing. When changing the simulation profile, processing similar to the change processing of the device profile is also performed. If the number of non-check lines in the after-matching image storage table is larger than 0 (YES in step S1604), in step S1605, the server 104 (color matching processing unit 206) picks a line from non-check lines and checks whether the picked line has the matching image reception client ID and device ID acquired in step S1601 by referring to the after-matching image storage table. If the server 104 (color matching processing unit 206) checks the picked line does not have the matching image reception client ID and device ID (NO in step S1605), instep S1606, the number of non-check lines is decremented.

If the server 104 (color matching processing unit 206) has found the line having the matching acquired image reception client ID and device ID (YES in step S1605), in step S1607, the server 104 (color matching processing unit 206) deletes the image data after matching in the after-matching image storage table. In step S1608, the server 104 (color matching processing unit 206) performs the color matching processing of the original image data with another information.

The profile used for the color matching processing is the device profiles acquired from the table of “the image transmission client ID to the device profile” and “the table of the image reception client ID to the device profile” based on information on the matched line.

The device profile acquired from the table of “the image transmission client ID to the device profile” is the device profile specified by the image transmission client ID and device ID of the image transmission client in the matched line.

The device profile acquired from the table of “the image reception client ID to the device profile” is the device profile specified by the image reception client ID and device ID of the image reception client in the matched line and the simulation profile specified by the simulation device ID.

In step S1609, the server 104 (color matching processing unit 206) stores the image data after matching. Then, the server 104 (image storage processing unit 207) updates the after-matching image storage table. If the line in which the acquired image reception client ID and the device ID of the image reception client is not found (No in step S1604), the processing ends.

When the simulation profile is changed, similar processing to the processing when the device profile is changed.

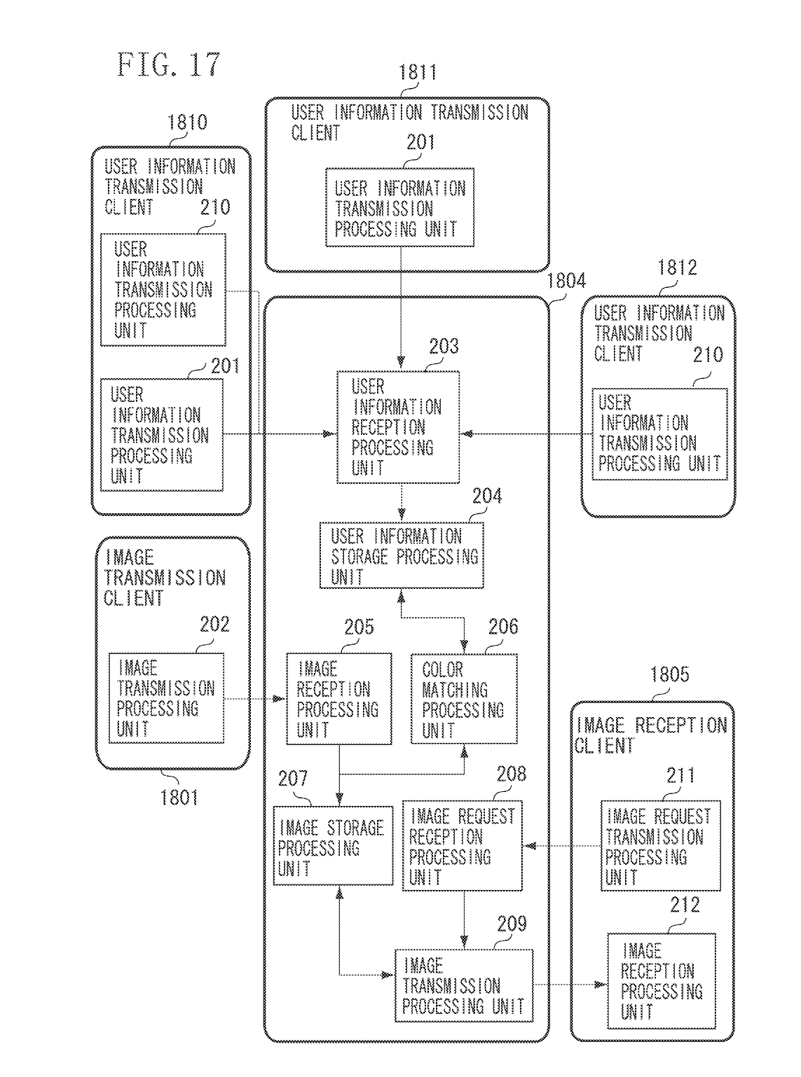

According to a second exemplary embodiment, the client computer including both/either the user information transmission processing unit 201 and/or the user information transmission processing unit 210 according to the first exemplary embodiment is defined as the user information transmission client 1810, 1811, 1812, as shown in FIG. 17. According to the present exemplary embodiment, the image transmission client 1801 illustrated in FIG. 17 includes image transmission processing unit 202, and the image reception client 1805 illustrated in FIG. 17 includes both image request transmission processing unit 211 and the image reception processing unit 212. The server 1804 is the same as the server 104 illustrated in FIG. 2. FIG. 17 is an association diagram illustrating internal processing in the configuration of the network system according to the present exemplary embodiment. Here, the network system according to the present exemplary embodiment is almost the same as the network system illustrated in FIG. 1. Namely, the above clients and the server connect each other via a network. The internal processing performed by each unit in each client/server in FIG. 17 is described above with reference to FIG. 2.

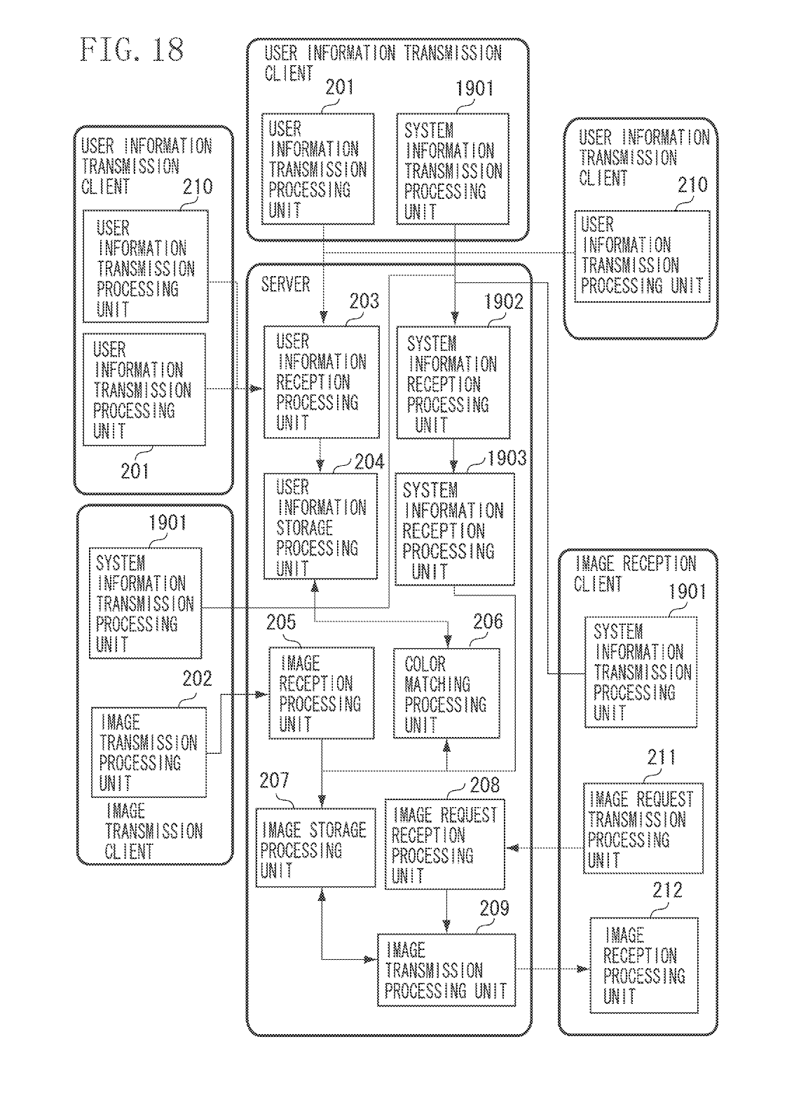

According to a third exemplary embodiment, FIG. 18 illustrates an association diagram illustrating internal processing of a network system additionally having processing for setting an image storage period with the system configuration according to the first and second exemplary embodiments. Here, the network system according to the present exemplary embodiment is almost the same as the network system illustrated in FIG. 1. Namely, the above clients and the server connect each other via a network.

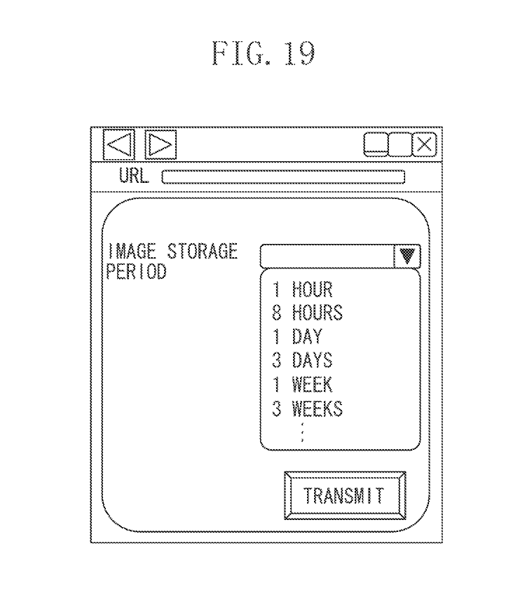

A system information transmission processing unit 1901 is included in each of the image transmission client, the image reception client, and the user information transmission client. The system information transmission processing unit 1901 transmits information on an image storage period to the server 104 via a user interface for setting an image storage period illustrated in FIG. 19.

A system information reception processing unit 1902 (period information reception unit) receives the information on the image storage period transmitted from the system information transmission processing unit 1901, and transmits the received information to a system information storage processing unit 1903.

The system information storage processing unit 1903 stores the information on the image storage period transmitted from the system information reception processing unit 1902 to the server 104, and transmits the information on the image storage period to the image storage processing unit 207 in response to a request therefrom.

The image storage processing unit 207 performs the following processing in addition to the processing according to the first exemplary embodiment. That is, the image storage processing unit 207 stores the information received from the image reception processing unit 205 and the reception date and time of the received image.

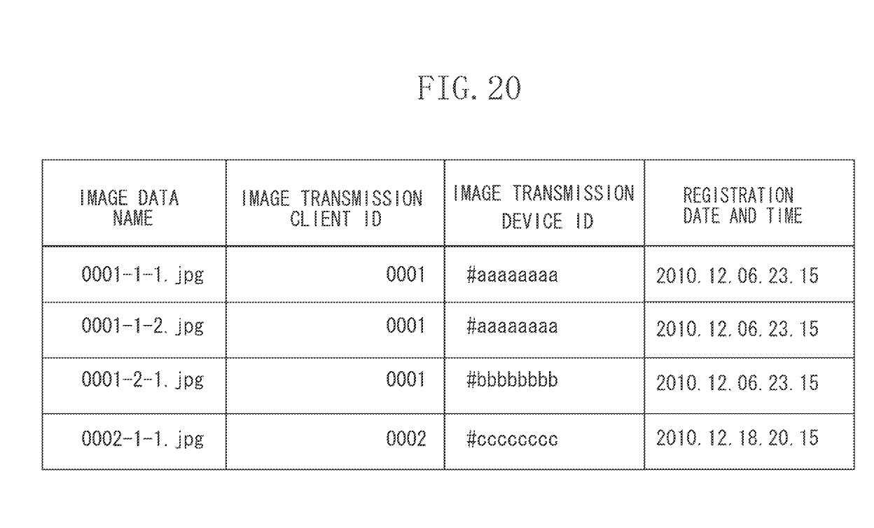

Although the original image storage table in FIG. 8 is used in the first exemplary embodiment, an original image storage table in FIG. 20 is used in the present exemplary embodiment.

The image storage processing unit 207 acquires the information on the image storage period from the system information storage processing unit 1903 for each predetermined period. Then, the image storage processing unit 207 deletes lines having information of which the image storage period is elapsed from the original image storage table in FIG. 20 by comparison with the reception date and time therein. Further, the image storage processing unit 207 deletes the original image.

The image storage processing unit 207 searches for the image data after matching about the deleted original image from the after-matching image storage table in FIG. 9, and deletes the corresponding line and the image data after matching. Another processing is similar to that according to the first and second exemplary embodiments.

According to the exemplary embodiments described above, the database is in the HDD of the server 104. However, the present invention is not limited to this. For example, the database may be provided in an external file server connected to the server 104 via a local network.

The present invention is realized by executing the following processing. That is, the processing is performed by supplying software (computer program) for realizing the functions according to the exemplary embodiments to a system or an apparatus via a network or various storage media (e.g., a computer readable storage medium), and reading and executing the program by a computer (or a CPU, a micro processing unit (MPU), and/or the like) of the system or the apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-047912 filed Mar. 4, 2011, which is hereby incorporated by reference herein in its entirety.

What is claimed is:

1. An image processing apparatus that performs color matching processing on original image data by using first color reproduction information and second color reproduction information stored in a database, and generates image data after matching, the image processing apparatus comprising:
a management unit configured to manage first relevant information for associating first user identification information transmitted together with the original image data and second user identification information transmitted together with a request of the image data after matching, second relevant information for associating the first user identification information and the first color reproduction information, and third relevant information for associating the second user identification information and the second color reproduction information;
an image reception unit configured to receive the original image data together with the first user identification information;
a generation unit configured to generate the image data after matching by performing the color matching processing on the original image data received by the image reception unit by using the first and second color reproduction information specified based on the first user identification information received by the image reception unit and the relevant information managed by the management unit; and
a storage unit configured to store the image data after matching generated by the generation unit in the database.

2. The image processing apparatus according to claim 1,
wherein the generation unit generates the image data after matching in advance of a request of transmission of the image data after matching.

3. The image processing apparatus according to claim 1, further comprising:
a user information reception unit configured to receive the first user identification information, the second user identification information, the first color reproduction information, and the second color reproduction information,
wherein the management unit manages the first, second, and third relevant information by associating the information received by the user information reception unit to each other.

4. The image processing apparatus according to claim 1, wherein the second relevant information includes information indicating that device identification information corresponding to the first color reproduction information is associated with the first color reproduction information, and
the third relevant information includes information indicating that device identification information corresponding to the second color reproduction information is associated with the second color reproduction information.

5. The image processing apparatus according to claim 1, further comprising:
a change unit configured to change the second color reproduction information with respect to the relevant information managed by the management unit,
wherein the storage unit deletes the image data after matching corresponding to the second color reproduction information before changing by the change unit.

6. The image processing apparatus according to claim 1, further comprising:
a period information reception unit configured to receive the original image data and information on the image storage period of the image data after matching,
wherein the original image data and the image data after matching are deleted from the database based on the information on the image storage period received by the period information reception unit.

7. An information processing apparatus connected to the image processing apparatus according to claim 1 via a network, the information processing apparatus comprising:
a data transmission unit configured to transmit the original image data to the image processing apparatus; and
a first relevant information transmission unit configured to transmit the first color reproduction information and the first user identification information to the image processing apparatus.

8. An information processing apparatus connected to the image processing apparatus according to claim 1 via a network, the information processing apparatus comprising:
a second relevant information transmission unit configured to transmit the second color reproduction information and the second user identification information;
an image requesting unit configured to request the image data after matching; and
a reception unit configured to receive the image data after matching requested by the image requesting unit.

9. An image processing method of an image processing apparatus that performs color matching processing on original image data by using first color reproduction information and second color reproduction information and generates image data after matching, the image processing apparatus having a storage unit configured to store first relevant information for associating first user identification information transmitted together with the original image data and second user identification information transmitted together with a request for the image data after matching, second relevant information for associating the first user identification information and the first color reproduction information, and third relevant information for associating the second user identification information and the second color reproduction information, the image processing method comprising:
receiving the original image data together with the first user identification information;
generating the image data after matching by performing the color matching processing on the received original image data by using the first and second color reproduction information specified based on the received first user identification information and the managed relevant information; and
storing the generated image data after matching in a database.

10. A non-transitory computer-readable storage medium that stores a computer program to enable one or a plurality of micro processors to execute processing for generating image data after matching by performing color matching processing on original image data by using first color reproduction information and second color reproduction information, the computer program enabling the one or plurality of micro processors to function as:
a management unit configured to manage first relevant information for associating first user identification information transmitted together with the original image data and second user identification information transmitted together with a request for the image data after matching, second relevant information for associating the first user identification information and the first color reproduction information, and third relevant information for associating the second user identification information and the second color reproduction information;
an image reception unit configured to receive the original image data together with the first user identification information;
a generation unit configured to generate the image data after matching by performing the color matching processing on the original image data received by the image reception unit by using the first and second color reproduction information specified based on the first user identification information received by the image reception unit and the relevant information managed by the management unit; and
a storage unit configured to store the image data after matching generated by the generation unit in a database.
